(19) United States
(12) Patent Application Publication
(10) Pub. No.: US 2013/0138583 A1
(43) Pub. Date: May 30, 2013

(54) Lighters having manufacturer coupons

(71) Applicants: Marcus L. Thuesen, Houston, TX (US); Lejo C. Brana, Houston, TX (US); Richard D. Booker, Houston, TX (US)

(72) Inventors: Marcus L. Thuesen, Houston, TX (US); Lejo C. Brana, Houston, TX (US); Richard D. Booker, Houston, TX (US)

(21) Appl. No.: 13/374,471

(22) Filed: Dec. 29, 2011

Related U.S. Application Data
(60) Provisional application No. 61/569,769, filed on Dec. 12, 2011.
(60) Provisional application No. 61/564,296, filed on Nov. 28, 2011.

(51) Int. Cl. G06Q 90/00; B65D 69/00; F23Q 2/34

(52) U.S. Cl. 705/500; 431/253; 206/223

(57) ABSTRACT

Cigarette lighters and packaged lighters are provided for. The lighters and packaged lighters are provided with a manufacturer coupon. Methods for providing manufacturer coupons for dissemination to a target consumer group also are provided for. Preferred embodiments of the novel methods comprise packaging a cigarette lighter for retail distribution. The lighter is packaged with a removable coupon sheet. The coupon sheet provides a substrate on which said manufacturer coupon is imprinted and is removable by a consumer. The manufacturer coupon is redeemable by a consumer and includes machine readable code associated therewith to facilitate automated processing of the coupon.

### CLAIM TO PRIORITY

This application claims priority of the following provisional applications: “Lighter Having Manufacturer Coupons,” U.S. Ser. No. 61/569,769, filed Dec. 12, 2011; and “Lighter Having Manufacturer Coupons,” U.S. Ser. No. 61/564,296, filed Nov. 28, 2011.

### FIELD OF THE INVENTION

The present invention relates to lighters that provide a portable ignition source such as those commonly employed to light cigarettes and other tobacco products, and more particularly, to improved cigarette lighters having removable manufacturer coupons and to methods for disseminating manufacturer coupons to consumers via such improved lighters.

### BACKGROUND OF THE INVENTION

Advertisers have relied on many different ways to deliver advertising messages. For example, many advertisements are delivered through broadcast mass media, such as radio and television, or through printed mass media, such as magazines and newspapers. Direct advertising is another popular and often highly effective method because messages are delivered directly to a defined population of consumers. In addition to direct mail and e-mails, other direct advertising methods include dimensional mail, catalogs, and inserts in bills and other mailings.

Despite the many different media available to advertisers, however, there is a continuing need to develop effective, cost efficient methods of advertising. For example, while distribution by broadcast media is relatively inexpensive, the cost of producing entertainment, news and other content to attract an audience for broadcast media can be extremely expensive, and those costs are reflected in advertising fees. Content production costs for printed mass media also can be substantial, and printed mass media can be expensive to produce and distribute. While most direct advertising contains little or no content beyond the advertising message, and thus, involves relatively low content cost, the cost of direct advertising nevertheless can be substantial. Such costs typically include the generation of a mailing list and postage or other delivery costs.

Moreover, a substantial portion, if not the majority of all advertising messages are never viewed by their intended audience for one reason or another. Many consumers receiving the advertisement may have no interest in the advertised good or service, or they may not be able to afford it. There also is a general clutter of advertisements that makes it difficult for a particular ad to capture the attention of consumers, especially if the consumer is distracted or otherwise occupied when the opportunity for viewing the ad arises.

Inserts in newspapers and magazines typically have response rates on the order of 1-2%, although advertising in the newspaper or magazine itself has a lower response rate, usually under 1%. Direct mail, catalogs, and e-mails have average response rates around 2%. The response rates for all of these methods, however, are greatly reduced because the vast majority of the ads are never viewed. For example, most direct mailings are thrown away without ever being opened. Likewise, from 85% to 99% of e-mailings are never opened. Even when presented to a consumer, however, many ads are not really viewed because they are lost in the clutter of many other ads, and this is a common problem with newspaper inserts and some forms of direct mailings.

Thus, most advertising methods are very inefficient and wasteful. The effective cost for each advertising message that is actually communicated to consumers is generally many times higher than the nominal cost per message. Thus, despite, and in part because of the number and variety of conventional methods, advertisers continue to seek more cost effective ways of disseminating advertising messages. In particular, there is a continuing need for more effective and more economical methods for distributing manufacturer coupons.

Many products, such as food and consumer household products, are promoted extensively using manufacturer coupons. Such coupons typically offer a discount on specifically identified products. Consumers may redeem the coupons with merchants selling the product. The merchants in turn are reimbursed by the manufacturer or distributor of the product. The vast majority of manufacturer coupons are redeemed by merchants through a clearing house such as NCH Marketing Services, Deerfield, Ill. or Inmar, Winston-Salem, N.C. The automated processing of such manufacturer coupons essentially requires that they incorporate machine readable indicia, such as UPC bar codes utilizing the UCC/EAN-128 Article Numbering System or the GS 1 DataBar coupon codes. Information on standards for manufacturer coupons is publicly available, for example, through Uniform Code Council, Inc., Lawrenceville, N.J., and through Grocery Manufacturers of America, Inc., Wash., D.C.

Manufacturer coupons have been distributed by various methods, including newspaper and other print media inserts, direct mailings, and e-mailings. They also have been distributed as part of “cross ruffing” or “bounce back” offers. Such offers attach or include a coupon for a product in packaging for that product or another product, and many products can be easily adapted for use in carrying coupons. For example, cereal and other food products that are distributed in relatively large packages can easily accommodate manufacturer coupons. Many products, however, have relatively little imprintable area available for a bar code and even minimal product identification as is required to produce a consumer redeemable, manufacturer coupon. Many other products have not been recognized as vehicles for disseminating manufacturer coupons and especially as they may be utilized to disseminate coupons directed to specific products.

Merchant coupons are to be distinguished from manufacturer coupons. Merchant coupons offer discounts on products, but the discount is underwritten by the merchant who issues the coupon, not the manufacturer of the product. Thus, merchant coupons do not require a system for collecting, processing, and accounting for discounts as exists in relation to manufacturer coupons.

Thus, one or more aspects or embodiments of the subject invention address one or more of such disadvantages of the prior art and others, and provide one or more advantages over the prior art. Those and other objects and advantages of various aspects or embodiments of the invention will be apparent to those skilled in the art upon reading the following detailed description and upon reference to the drawings.

### SUMMARY OF THE INVENTION

The subject invention provides methods for providing manufacturer coupons for dissemination to a target consumer group. Preferred embodiments of the novel methods comprise packaging a cigarette lighter for retail distribution. The cigarette lighter is packaged with a manufacturer coupon. The manufacturer coupon may be imprinted on retail packaging for the lighter. Preferably, the manufacturer coupon is imprinted on a removable coupon sheet and packaged with the lighter, for example, by releasably affixing the coupon sheet to the lighter or by releasably affixing it to or inserting or capturing it in retail packaging for the lighter. The coupon sheet provides a substrate on which said manufacturer coupon is imprinted and is removable by a consumer. In any event, the manufacturer coupon is redeemable by a consumer and includes machine readable code associated therewith to facilitate automated processing of the coupon. The methods further comprise providing the lighters for distribution to a consumer outlet associated with the target consumer group whereby the manufacturer coupon may be provided to the target consumer group.

The subject invention also provides for novel cigarette lighters having manufacturer coupons and methods for distributing manufacturer coupons via cigarette lighters. In particular, broader embodiments of the subject invention provide for a cigarette lighter having a removable manufacturer coupon. Preferred embodiments of the novel lighters comprise a body having a chamber formed therein for holding liquid fuel. A coupon sheet is releasably affixed to the body. The coupon sheet provides a substrate on which the manufacturer coupon is imprinted and is separable from the body. The manufacturer coupon is redeemable by a consumer and includes machine readable code associated therewith to facilitate automated processing of the coupon. Preferably, the novel lighters comprise manufacturer coupons with a UPC bar code utilizing the UCC/EAN-128 Article Numbering System, the GS1 DataBar coupon codes, or another bar code.

It will be appreciated that the novel cigarette lighters may be used to efficiently and effectively distribute manufacturer coupons. Incorporating a coupon in the novel cigarette lighters does not appreciably increase the cost of distributing the lighters beyond those costs incurred in distributing conventional lighters. Thus, the cost of distributing manufacturing coupons via the novel cigarette lighters is relatively low, the cost being essentially the incremental cost of preparing the coupon itself.

Also, because cigarette lighters typically are handled many times by a consumer, they can provide an effective vehicle for displaying advertising. Accordingly, the subject invention encompasses methods for distributing manufacturer coupons via cigarette lighters. The method comprises releasably affixing a coupon sheet on a cigarette lighter. The coupon sheet provides a substrate on which the manufacturer coupon is imprinted and is separable from the lighter. The manufacturer coupon is redeemable by a consumer of the lighter and includes machine readable code associated therewith to facilitate automated processing of the coupon. The method further comprises providing the lighters for distribution to a consumer outlet associated with a target consumer group so that the manufacturer coupon may be provided to the target consumer group. Thus, consumers receiving the lighters are provided with an opportunity to view and redeem the coupon.

Other preferred methods of the subject invention further comprise packaging the novel lighters in a shipping carton having a machine readable indicator assigned to the manufacturer coupon, reading the indicator and in response thereto shipping the shipping carton to a consumer outlet associated with a target consumer group. Thus, lighters with the manufacturer coupon may be distributed to consumers associated with the consumer outlet and thereby disseminate the manufacturer coupon to the target consumer group.

Preferably, the manufacturer coupon relates to tobacco products and the lighters are distributed through retail outlets that offer cigarettes and other tobacco products for sale. The novel lighters also may be distributed free of charge at the point of sale, for example, when cigarettes are purchased, or as promotional premium items. It is expected, therefore, that the view and redemption rates for manufacturer coupons distributed via the novel methods will be significantly greater than view rates for other types of direct advertising.

The subject invention also provides for novel packaged cigarette lighters having manufacturer coupons and methods for distributing manufacturer coupons via packaged cigarette lighters. A manufacturer coupon may be imprinted on retail packaging for the lighter. Preferably, a coupon sheet may be provided which provides a substrate upon which the manufacturer coupon is imprinted. The coupon sheet may be releasably affixed to retail packaging, or it may be inserted into or captured in retail packaging.

In particular, broader embodiments of the subject invention provide for a packaged cigarette lighter having a removable manufacturer coupon. Preferred embodiments of the novel packaged lighters comprise a backing and a cover. The cover defines a cavity receiving the lighter and is connected to the backing such that the backing and cover substantially enclose the lighter. A coupon sheet is releasably affixed to the backing. The coupon sheet provides a substrate on which the manufacturer coupon is imprinted and is separable from the backing. The coupon sheet may be releasably affixed to the cover as well. Other broad embodiments comprise capturing a coupon sheet in film wraps partially or completely enveloping a lighter and in packets enclosing a lighter.

In any event, the manufacturer coupon is redeemable by a consumer and includes machine readable code associated therewith to facilitate automated processing of the coupon. Preferably, the novel packaged lighters comprise manufacturer coupons with a UPC bar code utilizing the UCC/EAN-128 Article Numbering System, the GS 1 DataBar coupon codes, or another bar code.

It will be appreciated that the novel packaged cigarette lighters may be used to efficiently and effectively distribute manufacturer coupons. Incorporating a coupon in the novel packaged cigarette lighters does not appreciably increase the cost of distributing the packaged lighters beyond those costs incurred in distributing conventional packaged lighters. Thus, the cost of distributing manufacturing coupons via the novel packaged cigarette lighters is relatively low, the cost being essentially the incremental cost of preparing the coupon itself.

Also, because a consumer often has to unpackage the cigarette lighter to use it, the packaging can provide an effective vehicle for displaying advertising. Accordingly, the subject invention encompasses methods for distributing manufacturer coupons via packaged cigarette lighters. The method comprises packaging a cigarette lighter in retail packaging which has a manufacturer coupon. The manufacturer coupon may be imprinted on the retail packaging, or it may be imprinted on a separable coupon sheet which is releasably affixed to the retail packaging or captured therein.

Preferred embodiments utilize retail packaging that comprises a backing and a cover. The cover defines a cavity receiving the lighter, and the backing and cover substantially enclose the lighter. The method further comprises releasably affixing a coupon sheet to the backing. The coupon sheet provides a substrate on which the manufacturer coupon is imprinted and is separable from the backing. The coupon sheet may be releasably affixed to the cover as well. In any event, the manufacturer coupon is redeemable by a consumer of the lighter and includes machine readable code associated therewith to facilitate automated processing of the coupon. The method further comprises providing the packaged lighters for distribution to a consumer outlet associated with a target consumer group so that the manufacturer coupon may be provided to the target consumer group. Thus, consumers receiving the packaged lighters are provided with an opportunity to view and redeem the coupon.

The subject invention further provides for novel bulk retail packaging for cigarette lighters. The packaging is suitable for presentation at the point of sale and has a plurality of manufacturer coupons. Methods of distributing manufacturer coupons via bulk packaged cigarette lighters also are provided. In particular, broader embodiments of the subject invention provide for point-of-sale caddies having a removable manufacturer coupon, usually a plurality of removable manufacturer coupons. Preferred embodiments of the novel caddies comprise a tray which receives a plurality of cigarette lighters, preferably in individual recesses provided therein. A display backing extends upward from one end of the tray. A coupon sheet or, as would be more typical, a plurality of coupon sheets is releasably affixed to the backing. The coupon sheets provide a substrate on which the manufacturer coupons are imprinted and are separable from the backing. The manufacturer coupons are redeemable by consumers and include machine readable code associated therewith to facilitate automated processing of the coupons. Preferably, the manufacturer coupons include a UPC bar code utilizing the UCC/EAN-128 Article Numbering System, the GS 1 DataBar coupon codes, or another bar code.

It will be appreciated that the novel bulk retail packaging may be used to efficiently and effectively distribute manufacturer coupons. Incorporating coupons in the novel packaging does not appreciably increase the cost of distributing cigarette lighters beyond those costs incurred in distributing cigarette lighters in conventional bulk packaging. Thus, the cost of distributing manufacturing coupons, for example, via the novel bulk packaging is relatively low, the cost being essentially the incremental cost of preparing the coupon itself.

Also, because such bulk packaging for this type of product typically is presented to consumers at the point of sale, the packaging can provide an effective vehicle for displaying advertising. Accordingly, the subject invention encompasses methods for distributing manufacturer coupons via bulk packaging for cigarette lighters. The method comprises packaging a plurality of cigarette lighters in a point-of-sale caddy having a removable manufacturer coupon, usually a plurality of removable manufacturer coupons. Preferred embodiments of the novel caddies comprise a tray which receives a plurality of cigarette lighters, preferably in individual recesses provided therein. A display backing extends upward from one end of the tray. A coupon sheet or, as would be more typical, a plurality of coupon sheets is releasably affixed to the backing. The coupon sheets provide a substrate on which the manufacturer coupons are imprinted and are separable from the backing. The manufacturer coupons are redeemable by consumers and include machine readable code associated therewith to facilitate automated processing of the coupons. The method further comprises providing the caddy for distribution to a consumer outlet associated with a target consumer group so that the manufacturer coupon may be provided to the target consumer group. Thus, consumers viewing or purchasing the packaged lighters are provided with an opportunity to view and redeem the coupon.

Other preferred methods of the subject invention further comprise packaging the novel bulk packaged lighters in a shipping carton having a machine readable indicator assigned to the manufacturer coupon, reading the indicator and in response thereto shipping the shipping carton to a consumer outlet associated with a target consumer group. Thus, bulk packaged lighters with the manufacturer coupon may be distributed to consumers associated with the consumer outlet and thereby disseminate the manufacturer coupon to the target consumer group.

Preferably, the manufacturer coupon relates to tobacco products and the bulk packaged lighters are distributed through retail outlets that offer cigarettes and other tobacco products for sale. The novel bulk packaged lighters also may be distributed free of charge at the point of sale, for example, when cigarettes are purchased. It is expected, therefore, that the view and redemption rates for manufacturer coupons distributed via the novel methods will be significantly greater than view rates for other types of direct advertising.

Those and other aspects of the invention, and the advantages derived therefrom, are described in further detail below.

### BRIEF DESCRIPTION OF THE DRAWINGS

FIG. 1 is a plan view of a preferred embodiment 10 of the lighters of the subject invention, which lighter 10 has a coupon sheet 17 releasably affixed thereto.

FIG. 2 is a perspective view of the preferred lighter 10 shown in FIG. 1.

FIG. 3 is a plan view of another preferred embodiment 20 of the lighters of the subject invention, which lighter 20 has a pair of coupon sheets 27 releasably affixed thereto.

FIG. 4 is a perspective view of the preferred lighter 20 shown in FIG. 3.

FIG. 5 is a front elevational view of a preferred embodiment 30 of the lighters of the subject invention, which lighter 30 has a separable coupon sheet 37 attached to lighter 30 by an elastic loop 38.

FIG. 6 is a perspective view of a preferred embodiment 40 of the packaged lighters of the subject invention, which packaged lighter 40 has a coupon sheet 47.

FIG. 7 is a rear plan view of preferred packaged lighter 40 shown in FIG. 6, which view shows coupon sheet 47 releasably affixed to a backing 42 of packaged lighter 40.

FIG. 8 is a front elevational view of a preferred embodiment 50 of the lighters of the subject invention, which lighter 50 has a coupon sheet 57 secured thereto by a shrink wrap sleeve 58.

FIG. 9 is a front elevational view of an embodiment 60 of the lighters of the subject invention, which lighter 60 has a coupon sheet 67 packaged with lighter 60 in a wrapper 68.

FIG. 10 is a perspective view of a preferred embodiment 70 of lighters packaged in a caddy 71 having a plurality of coupon sheets 77.

FIG. 11 is a perspective view of a shipping carton 80 having a machine readable indicator 81 in which novel cigarette lighters may be shipped in accordance with the subject invention, a single novel cigarette lighter 10 being shown therein in phantom.

### DESCRIPTION OF ILLUSTRATIVE EMBODIMENTS

The subject invention is directed to methods for disseminating manufacturer coupons to consumers. The novel methods include methods wherein a manufacturer coupon is packaged with a cigarette lighter. The manufacturer coupon may be imprinted on retail packaging for the lighter. Preferably, it is imprinted on a coupon sheet which is releasably affixed to the lighter, or is releasably affixed to or captured in the retail packaging. Thus, the manufacturer coupon is removable from the lighter or its packaging. In any event, the manufacturer coupon is redeemable by a consumer of the lighter and includes machine readable code associated therewith to facilitate automated processing of the coupon. The lighter, including its retail packaging and the coupon, then is distributed to a consumer outlet and finally to consumer associated with the consumer outlet. Thus, consumers receiving the cigarette lighters are provided with an opportunity to view and redeem the coupon.

It will be appreciated that the cost of distributing manufacturer coupons via the novel methods is, in a sense, free. That is, the novel methods take advantage of the existing distribution methods for cigarette lighters. Coupons may be effectively disseminated for little incremental cost over the normal costs of producing and distributing cigarette lighters.

In the novel methods, cigarette lighters are packaged for retail distribution with a manufacturer coupon. That is, a manufacturer coupon is provided on the cigarette lighter itself or on or in retail packaging for the lighter. Retail packaging, as is commonly understood, refers to packaging, including individual packs, combo packs, or bulk packaging in which the cigarette lighter is presented to consumers for purchase at retail outlets or in which it may otherwise be distributed to consumers, for example, as a give-away or premium item.

Manufacturer coupons, as used herein, include coupons that may redeemed by a consumer at a retailer who is then reimbursed by the manufacturer of the product or sponsor of the service. It will be appreciated that many branded products and services are not actually manufactured or provided by the brand owner. A “manufacturer” often contracts with others for the manufacture, assembly, or fabrication of their product, or for the provision of their service, and then brands it as its own and introduces it into the stream of commerce. In any event, a manufacturer coupon is the tangible article by which the “manufacturer” informs consumers of a discount being offered on its products and reimburses retailers who honor that discount.

Preferably the coupon includes the common features of coupons commonly in use. Such features include an offer value, such as “$1 Off”, and additional offer details such as an indication of the product, package size, locations where the coupon may be redeemed, and an expiration date. The manufacturer coupon incorporates machine readable indicia, such as bar codes, that will facilitate the automated processing of the coupon. Preferably the bar codes imprinted on the coupon sheet meet standards for UPC bar codes utilizing the UCC/EAN-128 Article Numbering System and the GS 1 DataBar Coupon code as are known in the industry, or for matrix or two-dimensional bar codes, such as quick response (QR) codes, but other codes may be used and other information may be encoded therein. It also will be appreciated that other machine readable indicia may be provided in association with the coupon or other advertising message, such as suitably encoded magnetic media films or ink. Codes also may be embedded via Wiegand cards, proximity cards, contact and contactless smart cards, RFID tags, and such which utilize embedded ferromagnetic wires, LC circuits, microprocessors, memory, radio frequency transmitters/receivers, and the like. Not all such technologies may be cost efficient for disseminating manufacturer coupons or offer codes at present, but they may be used if desired. Generally speaking, the subject invention may employ such codes, or such other indicia and readers and systems as may hereafter be developed or put into common use for processing coupons.

The packaged cigarette lighters, with the manufacturer coupon, then are distributed to consumer outlets. The consumer outlets may be any distributor of cigarette lighters to consumers. The cigarette lighters also could be distributed by a sponsor of the cigarette lighters, that is, the sponsor may distribute the cigarette lighters directly through their own consumer outlets or through other consumer outlets to be given away to consumers free of charge in order to disseminate the sponsor's advertising message or a manufacturer coupon provided by the sponsor. Such sponsors traditionally have included a variety of consumer retail outlets, such as convenience stores, which purchase cigarette lighters having the sponsor's message custom printed on the lighter or packaging for the lighter. The sponsor's advertising message is usually a relatively simple branding message.

The manufacturer coupon may be directed to any product, but preferably it pertains to a product of interest to consumers of cigarette lighters or to consumers of a sponsor's product or services. For example, manufacturer coupons directed to alcohol or tobacco products may be provided on cigarette lighters distributed through restaurants, taverns, and other food and beverage service outlets. It also will be appreciated that consumers in such outlets often have a greater opportunity to view advertising messages while they wait for and consume food and beverages. It is expected, therefore, that the view rates for manufacturer coupons distributed via the novel cigarette lighters will be significantly greater than view rates for other types of direct advertising. Similarly, the novel cigarette lighters, especially those having manufacturer coupons for tobacco products, also may be distributed through retailers of tobacco products, even as a “freebie” accompanying the purchase of tobacco products. Such point-of-sale distributions are likely to lead to higher view and redemption rates.

Preferably, the manufacturer coupons are directed to a target consumer audience. For example, an advertiser may wish to limit its campaign to consumers in a specific geographical area or associated with specific types of consumer outlets. Thus, the novel methods allow for efficient and effective dissemination of manufacturer coupons to targeted consumers.

For example, the novel methods most commonly will involve the flow of information through four basic entities, (1) an agency that coordinates the flow of information from (2) a client who desires to disseminate a coupon, (3) a cigarette lighter manufacturer who manufacturers or packages cigarette lighters for distribution by or under the authority of (4) a perceived source or sponsor of the cigarette lighters whose message occupies other advertising space on the cigarette lighter or packaging for the lighter. It will be appreciated, of course, that in some situations, those entities may be the same entity, such as when a manufacturer desires to disseminate a coupon that may be included toward future purchases of cigarette lighters or a sponsor who wishes to distribute a coupon for its own product or service. The perceived source of the cigarette lighters typically will be the manufacturer, but the cigarette lighters may be distributed by a sponsor, a third party who is presenting an advertising message on the cigarette lighter or its packaging. Any of those entities may utilize subcontractors, suppliers, and the like. The manufacturer also may act as its own agency and deal directly with advertising sponsors and clients who want their coupons disseminated.

The process generally begins with coupon specifications provided to the agency by the client. Those specifications include instructions as to the content and format of the coupon to be provided with the cigarette lighters, the quantity of coupons to be disseminated and the time period over which the coupons will be distributed. The instructions also may include the consumers to whom the coupon will be disseminated. It will be appreciated that a particular coupon may be targeted to particular consumers by associating the coupon with cigarette lighters to be distributed in a particular geographical area, through particular sponsors or consumer outlets or types of sponsors or consumer outlets, or a combination of those and other factors believed to be associated with the targeted consumers.

The coupon specifications of the client will be coordinated with specifications provided by the source or sponsor as to information that also will appear on the cigarette lighter or packaging for the cigarette lighters, such as the manufacturer's trademark or the sponsor's advertising message. In particular, if the client has specified that its manufacturer coupon is to be disseminated through certain sponsor or types of sponsors, the client specifications will be coordinated with the specifications of the appropriate sponsors. It also will be appreciated that the coupon specifications will be coordinated, usually by the agency, with the production schedule of the manufacturer, especially where the coupon will be disseminated to targeted consumers, as the quantity of such coupons generally will be limited by expected production and sales levels for the sponsors with which the coupon will be associated.

Preferably, the client specifications are transmitted from a central computer maintained by the agency through a network, such as the Internet, dedicated, or dial-up networks, to a computer or computer system maintained by the manufacturer to control its inventory and operation of its manufacturing equipment. The manufacturer's system preferably is in communication with any subcontractor systems, such as systems maintained by a printer, so as to facilitate the preparation and subsequent packaging of the cigarette lighters. Also, once the appropriate packaging components have been imprinted in accordance with client and sponsor instructions, a code or other indicator, such as a bar code, may be assigned to components incorporating those instructions and stored in a machine readable format or medium which is printed, affixed, or otherwise. associated with the components themselves or the web roll, cassettes, jigs, or packaging in which the components are handled prior to their use in the packaging process.

The cigarette lighters then are packaged based on the client (or multiple client) specifications and the source or sponsor (or multiple sources or sponsors) specifications. For example, lighters will be packaged in the quantities specified by the client. The packaging may be accomplished by manually controlled packaging equipment. Preferably, however, once communicated directly to the manufacturer's computer system, the relevant client specifications, e.g., product quantity, are communicated to automated, computer controlled packaging equipment in the manufacturer's facility. The packaging equipment also are preferably provided with suitable readers for reading an indicator or code associated with the packaging components associated with a particular client and source or sponsor so that the packaging of lighters proceeds in accordance with their respective instructions. The equipment may also include suitable means, such as ink jet sprayers, to apply, affix, or otherwise associate a code or other indicator, such as a bar code, associated with the client manufacturer coupon which is in a machine readable format or medium to the cigarette lighters or their packaging.

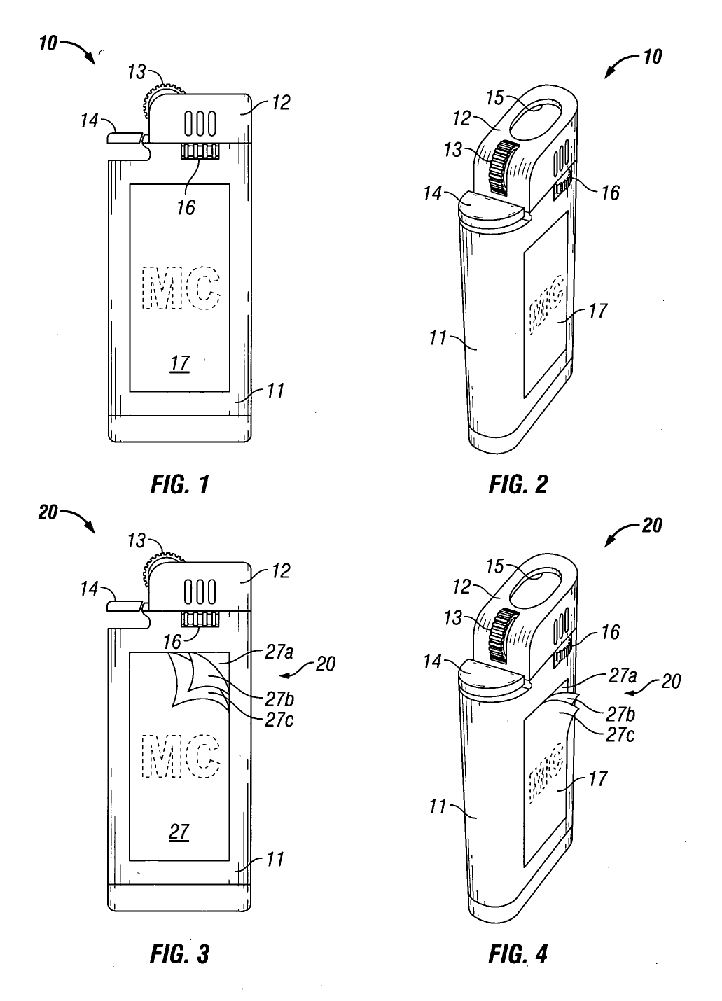

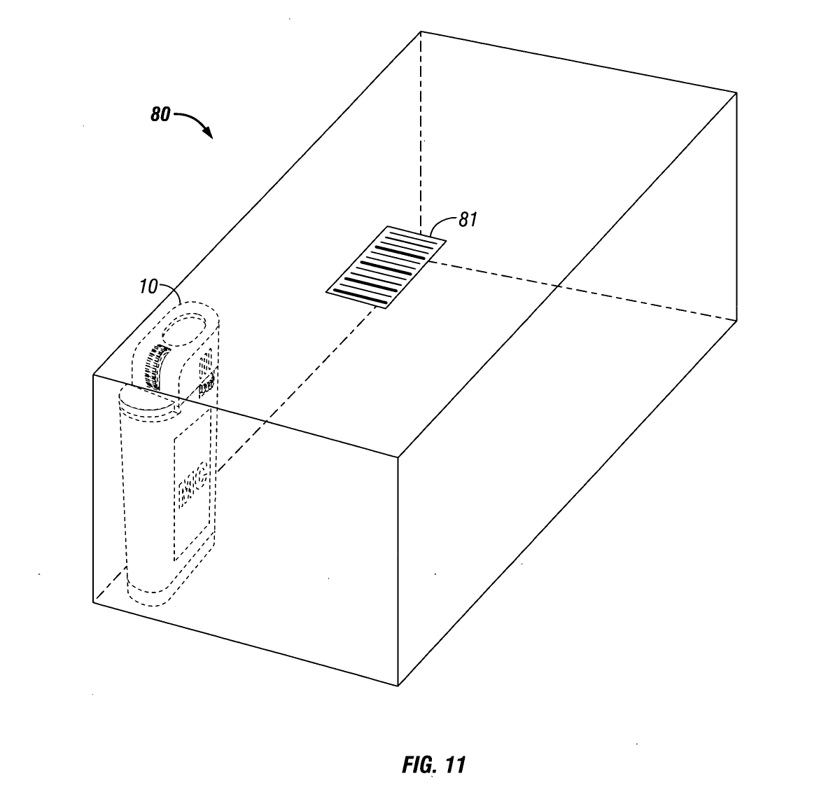

Once the lighters are packaged, the lighters with the coupon are packed and then distributed in accordance with the client specifications. For example, the client may have specified that the coupon be distributed only through particular consumer outlets, such as certain retailers or types of retailers, in certain geographic areas, or certain time periods. In particular, client specifications as to the distribution of the lighters may further its purpose of reaching targeted consumers. Preferably, packaged lighters are packed in a shipping carton having a machine readable indicator uniquely associated with the manufacturer coupon. The lighters may be packed in bulk or in packaging suitable for retail sale or display, such as packaging discussed below. For example, as illustrated in FIG. 11, packaged cigarette lighters, such as a plurality of novel cigarette lighter 10 described in further detail below and shown in further detail in FIGS. 1-2, may be packed in a shipping carton 80 that bears a machine readable code 81. (For the sake of clarity, only a single lighter 10 is shown in phantom in FIG. 11.) The indicator then is read and, in response to the reading, the carton containing the cigarette lighters, either packed in bulk or in retail packaging, is shipped to consumer outlets associated with the target consumer group or otherwise in accordance with the client's instructions. The manufacturing coupon then may be disseminated, though dissemination of the cigarette lighters, to the target consumer group through the consumer outlets.

The machine readable indicator, and the apparatus for reading such indicators, may be selected from any such systems as are known in the art For example, the indicator could be a bar code readable by conventional bar code readers, such as bar code 81 on shipping carton 80 shown in FIG. 11. Alternately, the indicator could be text, numerical, or graphical code that may be scanned and interpreted by conventional scan readers. Other indicators include Wiegand cards, proximity cards, contact and contactless smart cards, RFID tags, and the like which utilize embedded ferromagnetic wires, LC circuits, microprocessors, memory, radio frequency transmitters/receivers, and such to record data and which may be read by various readers. Not all such technologies may be cost efficient, but they may be used if desired. Generally speaking, the subject invention may employ any such indicators as are known, or may hereafter be developed.

The subject invention is also directed to novel cigarette lighters which are packaged with removable manufacturer coupons. The invention may be applied to any conventional cigarette lighter, and there are a variety of designs for such lighters that are known and are commercially available. It will be appreciated, however, that cigarette lighters are not to be understood in the sense of something that is capable of lighting a cigarette. Thermonuclear devices are capable of lighting cigarettes, but they are not within the scope of the subject invention. Instead, a “cigarette lighter” will be understood as a device that provides a portable ignition device and is manufactured, sold, and used generally for the purpose of lighting cigarettes.

Such lighters include those utilizing a volatile liquid fuel, such as naphtha or butane, and a wick which is ignitable by a striker. The strikers typically are a metal wheel that rotates against a flint or a piezoelectric crystal igniter. Examples of this type include the well-known Zippo® cigarette lighters. Cigarette lighters also include so-called permanent matches. Permanent matches have a fuel-filled reservoir and a metal rod assembly or “match” which is normally inserted into the. reservoir. When the “match” is removed, it serves as both a striker and a wick. There also are so-called flameless lighters which utilizes an enclosed heating element such as electrically heated wire or coil.

Perhaps the most common lighters, however, are so-called disposable lighters, such as the well know line of Bic disposable lighters. They are not designed to be refilled and are disposed of once their fuel is exhausted. Such lighters have a body, usually made of molded plastic, which forms a chamber or reservoir in which a volatile liquid fuel is loaded. The fuel most commonly is butane. The chamber is closed by a cap assembly that also provides flow control and a spark for gas flowing out of the reservoir. The spark source typically is a wheel that may be rotated by a user's thumb against a flint, although piezo igniters are sometimes provided. A pivoting valve stem, which can be depressed by a user at essentially the same time as the wheel is rotated, allows gas to flow past the spark, where it is ignited. Such lighters also typically have some means for controlling the amount of gas released when the valve stem is depressed. The subject invention contemplates the use of those conventional lighters and many others, and may be viewed as improvements on conventional cigarette lighters.

More particularly, various preferred embodiments of the subject invention are directed to cigarette lighters which have a manufacturer coupon, either on the lighter or on packaging for the lighter. For example, a first preferred embodiment comprises a cigarette lighter having a chamber formed therein for holding liquid fuel. A coupon sheet is releasably affixed to the body. The coupon sheet provides a substrate on which the manufacturer coupon is imprinted and is separable from the body. The manufacturer coupon is redeemable by a consumer and includes machine readable code associated therewith to facilitate automated processing of the coupon.

For example, lighter 10 shown in FIGS. 1-2, comprises a body 11 that defines a chamber which is filled with volatile liquid fuel and is closed by a cap assembly 12. A rotatable spark wheel 13 is mounted in cap assembly 12 which, when rotated, moves against a flint (not shown) to produce a spark. A pivoting valve stem 14 is mounted adjacent to wheel 13 such that it may be pressed down and open a normally shut valve (not shown) which allows vaporized gas from the fuel chamber to flow out a nozzle (not shown) mounted within opening 15 in cap assembly. Gas then flows past the area in which the spark is created, thus, allowing a flame to be produced when wheel 13 is rotated as valve stem 14 is depressed. The flow capacity of the nozzle may be varied by an adjustment wheel 16. Those aspects, and other finer details on the design, assembly, and fabrication of the lighter per se will not be discussed herein in further detail. Such matters are well within the skill of those in the art, and a variety of lighters suitable for providing a mobile ignition source for cigarettes are known and may be used in the context of the subject invention.

In accordance with the subject invention, lighter 10 further comprises a coupon sheet 17. Coupon sheet 17 is releasably affixed to body 11. It provides a substrate on which is imprinted a manufacturer coupon having machine readable code to facilitate automated processing of the manufacturer coupon. Coupon sheet 17 is separable from body 11 so that a consumer may remove and redeem the manufacturer coupon.

Coupon sheet 17 may be releasably affixed to lighter 10 by a substantially continuous layer of adhesive extending across the entire or the substantial majority of the underside of coupon sheet 17. It is not necessary, however, and may not even be desirable to do so. Adhesive may be applied discontinuously, e.g., in spots or lines. Also, coupon sheets may be affixed at only one end thereof so as to make it readily apparent to the consumer that the manufacturer coupon may be removed from the lighter or simply to make the manufacturer coupon more conspicuous. Furthermore, even where the substantial portion of a coupon sheet is adhered to the lighter, areas near the edges of the coupon sheet may be left free of adhesive to facilitate removal of the coupon sheet by a consumer.

The imprintable coupon sheets may be releasably affixed to the novel cigarette lighters and packaging by conventional methods and materials, but generally adhesives, especially peelable adhesives, will be used. For example, if the material from which the product or coupon sheet is fabricated is itself heat sealable, such as low density polyethylene (LDPE), the coupon sheet may be lightly or spot bonded to the cover. Preferably, however, either the product or coupon sheet is coated or spotted in appropriate locations with a heat sealable adhesive, such as those composed of polyethylene and other thermoplastic polymers, or a pressure sensitive, peelable, low tack adhesive so that the coupon sheet may be removed easily and without damaging it. Any suitable method for releasably affixing coupon sheets to the product, however, may be used, provided that the coupon sheet is sufficiently secure during shipment and distribution, but may be neatly and easily removed on the spot by a consumer of the product.

It also will be appreciated that references to removal of a coupon sheet and the like do not necessarily imply that the entire coupon sheet is removed or removable, only that the manufacturer coupon imprinted thereon may be removed. Portions of the coupon sheet may remain on a lighter. For example, one end of a coupon sheet may be adhered to the lighter in such a manner that it is not easily peeled away from the lighter. Perforations may be provided so that the unattached end, upon which a manufacturer coupon is imprinted, may be torn therefrom.

Coupon sheet 17 also is illustrated as having a single manufacturer coupon. Coupon sheets, however, can be divided into two or more coupon sheets defined, preferably, by lines of perforations that facilitate separation of the various sections of the coupon. It will be understood that perforations, as used herein, shall be understood to include a line of perforations extending through and along a substrate sheet, such as coupon sheet 17, as well as scoring of the sheet or any weakening thereof so that the substrate sheet may be torn along a predetermined line, thereby facilitating the removal of that portion of the sheet upon which is imprinted a manufacturer coupon without damage thereto or to other manufacturer coupons to which it may be connected.

Similarly, while exemplified lighter 10 has a coupon sheet 17 which lays flat on one side of body 11, that approach necessarily limits the size of a coupon sheet. A larger sheet may be provided by wrapping a coupon sheet around the body of a lighter. Moreover, if a larger coupon sheet is desired, either because the surface area available is too small or because it is reserved for other branding or advertising messages, a folded coupon sheet may be provided. For example, coupon sheet 17 on lighter 10 could be made twice as large and then provided with a medial fold so that the coupon sheet may be folded in on itself. Such folded sheets also could be provided with lines of perforations so that two or more coupon sheets are provided. If desired, folded coupon sheets could be tacked down, for example by a releasable adhesive, thereby requiring more consumer interaction with the coupon sheet.

Coupon sheets also may be provided on lighters via “onserts.” Such onserts have a base substrate that is affixed to the lighter, typically by adhesives. A coupon sheet in turn is affixed, typically with low tack adhesives, to the base substrate. The base substrate of the onsert is typically not removable in the ordinary course of use, but the coupon sheet may be peeled easily from the base substrate. Alternately, a flat or folded coupon sheet may be carried in a pocket formed by adhering a top, enveloping substrate layer to the onsert base substrate. The coupon sheet then would be removed by peeling or tearing away the top substrate layer of the onsert. In either event, the onset substrate layers would commonly be imprinted with various branding or other advertising messages, while the coupon sheet would provide a substrate for imprinting a manufacturer coupon. The onsert could be affixed to the lighter in any convenient location.

Another example of this first preferred embodiment is novel lighter 20 shown in FIGS. 3-4. Lighter 20 is identical to lighter 10 shown in FIGS. 1-2, except that multiple coupon sheets are provided via a laminate sheet 27. Laminate sheet 27 includes a first coupon sheet 27a which is releasably adhered to body 11. A second imprintable coupon sheet 27b is releasably adhered to coupon sheet 27a, and a third coupon sheet 27c is releasably adhered to coupon sheet 27b. Coupon sheets 27a, 27b, and 27c provide substrates on which are imprinted manufacturer coupons having machine readable code to facilitate automated processing of the coupons. Each coupon sheet 27 may be peeled away from lighter 20 in succession so that a consumer may remove and redeem the manufacturer coupons imprinted thereon. Preferably at least a portion of each coupon sheet 27 near its edges is not adhered to body 11 or its underlying coupon sheet 27a or 27b, as the case may, so that it may be more easily grasped and peeled by a consumer. The exposed sides of coupon sheets 27, if desired, may be imprinted with an advertising message alerting consumers to the presence of manufacturer coupons on the other side of or under coupon sheets 27.

It also will be appreciated that a laminate sheet may be provided with greater or fewer number of substrate layers. Likewise, one or more substrate layers in a laminate sheet may comprise more than one coupon sheet by providing lines of perforations therein. A “booklet” of coupon sheets also may be provided where only one end of the substrate layers are adhered together, thus allowing a consumer to flip through the coupon sheets and view the manufacturer coupons. In any event, the coupon sheets may be removed easily by a consumer so that manufacturer coupons imprinted thereon may be redeemed.

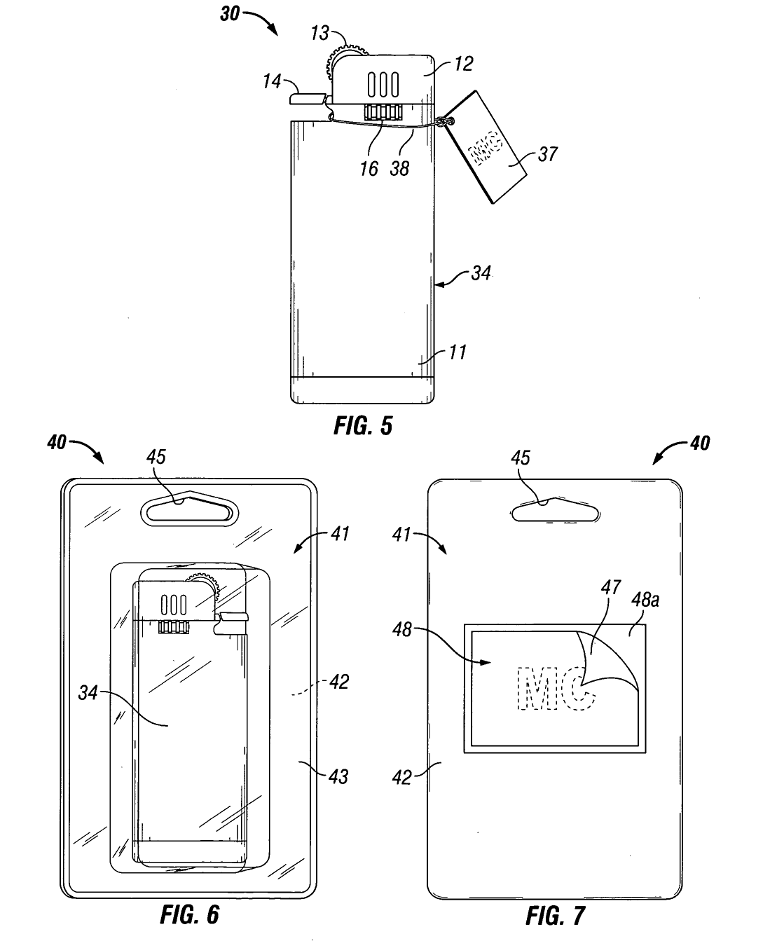

Another example of this first preferred embodiment is novel lighter 30 shown in FIG. 5. Lighter 34 is identical to lighter 10 discussed above and shown in FIGS. 1-2 except that it may or may not (as shown) have a removable coupon sheet. A coupon sheet 37 is releasably affixed by an elastic loop 38 wrapped around an aperture in coupon sheet 37 and lighter 30. Coupon sheet 37 provides a substrate on which is imprinted a manufacturer coupon having machine readable code to facilitate automated processing of the coupons. Coupon sheet 37 may be removed by a consumer, for example by tearing it away from elastic loop 38, so that the manufacturer coupon imprinted thereon may be redeemed.

It will be appreciated that coupon sheets such as coupon sheet 37 may be hung from the matchbook by a variety of other ties commonly used for hang tags. Such ties include cable ties, string loops, plastic worm loops, twist ties, and any number of other ties known in the art. Multiple coupon sheets, either folded or unfolded, also could be affixed with a single tie.

Thus, it will be appreciated that the invention provides for novel cigarette lighters having removable coupon sheets that may be easily and neatly removed and that present the coupon sheet in a manner appealing to consumers. Since they may be easily separated and removed from the lighters, removable coupon sheets are expected to increase redemption rates for the coupons imprinted thereon. There is a positive correlation between the ease with which a consumer is able to collect a coupon and the rate at which the coupon is redeemed. The harder it is to collect a coupon, the lower will be the redemption rates. Moreover, since lighters are handled many times by a consumer, typically thousands of times, the coupon inevitably will be noticed and detached from the lighter. The invention, however, is not limited to any particular method or means of releasably affixing a coupon sheet to a cigarette lighter. Other such methods and means are known in the art, or may hereafter be developed, and they may be employed in the broader aspects of the invention.

As noted previously, various embodiments of the subject invention also provide cigarette lighters packaged for retail sale or display where a manufacturer coupon is provided on or in the packaging. Such retail packaging may comprise retail packaging for an individual cigarette lighter, or for a relatively small number of cigarettes lighters packaged together in a two-pack, three-pack, or the like. The invention may be applied to any such conventional retail packaging, and there are a variety of designs that are known and are commercially available. It will be appreciated, however, that retail packaging is not to be understood in the sense of something that is capable of enclosing or packaging a cigarette lighters. A cigarette lighter could be packaged in the space shuttle, but the space shuttle is not within the scope of the invention. Instead, “retail packaging” will be understood to include primary packaging that first envelopes or holds a cigarette lighter or lighters so that they may be presented to consumers for purchase at retail outlets, with little or no setup, and which is manufactured, sold, and used generally for such purposes.

It will be appreciated that packaging is commonly categorized according to its proximity to the product itself. Primary packaging is the first level of packaging in which a product is packaged, and typically it defines the smallest unit or units of consumption. For lighters, an example of primary packaging would be the blister packs discussed below which contain a single or relatively small number of lighters. Secondary packaging typically packages a quantity of primary packaging. For example, a number of blister packs may be packaged in a carton for wholesale distribution to retailers, or they may be placed in a retail-ready caddy, so that they also are available for retail distribution to consumers. Finally, tertiary packaging typically packages a quantity of secondary packages, for example, when a number of cartons are placed in a shipping container for distribution to wholesalers.

Thus, as used herein, “retail packaging” will include what typically is viewed as primary packaging. It also may include packaging such as so called retail ready display which, especially when it contains a number of primary packages, may be viewed as secondary packaging. Such retail ready displays provide a container in which product may be shipped to retailers, but they also can be deployed with little or no setup, often on the sales counter or otherwise near the point of sale, to display product for sale.

One common type of primary packaging is so-called “blister packs,” and they are almost universally the packaging by which individual, or a relatively small number of cigarette lighters are packaged for retail distribution. Blister packs have a cavity or pocket which is formed in a web, usually a thermoformed plastic web made out of polyvinyl chloride or another transparent, thermoformable plastic. The web is attached to a backing, usually a paperboard backing, by, for example, heat or pressure sensitive adhesives.

A common variation on the blister pack is a so-called “clamshell” packaging. It is essentially the same configuration as a blister pack except that the backing also is made of a thermoformed plastic web. The clamshell may be formed from a single web and folded onto itself, or the cover and backing may be formed from separate webs. In either event, the cover and backing are secured to each other, very frequently by heat sealing or other bonding techniques, so that the product therein may be accessed only with some effort.

Thus, a second preferred embodiment comprises a packaged cigarette lighter having a manufacturer coupon, the lighter being packaged in primary packaging and having a separable coupon sheet releasably affixed thereto. More specific embodiments comprise retail packaging which comprises a backing and a cover. The cover defines a cavity receiving the lighter. It is connected to the backing such that the backing and the cover substantially enclose the lighter. A coupon sheet is releasably affixed to the backing or the cover. The coupon sheet provides a substrate on which the manufacturer coupon is imprinted and is separable from the body. The manufacturer coupon is redeemable by a consumer and includes machine readable code associated therewith to facilitate automated processing of the coupon.

For example, packaged lighter 40 shown in FIGS. 6-7 has been packed in a blister pack 41. Blister pack 41 comprises a backing 42 to which is secured a molded plastic cover 43. Molded plastic cover 43 defines a cavity which accommodates a cigarette lighter 34. Lighter 34 is identical to lighter 10 discussed above, except that it may or may not (as shown) have a removable coupon sheet. Similar packaging could enclose more than one lighter to provide, for example, a two-pack or a three-pack. In any event, cover 43 is attached to backing 42 by any number of conventional means, such as staples and adhesives, and backing 42 and cover 43 substantially enclose lighter 34. A hole 45 is provided in both backing 42 and cover 43 so that packaged lighter 40 may be hung on pegs in a retail display. It also will be noted that cover 43 is transparent, as is preferred, so that lighter 34 is visible to and may be inspected by consumers in its packaging. It also will be appreciated that openings may be provided in cover 43 so that a consumer may manipulate or otherwise access portions of lighter 34.

The cover preferably is formed from thermoformable plastics, such as polyvinyl chlorides, but polypropylenes, polystyrenes, polyethylene terephthalates, and high density polyethylenes also may be used if desired. The plastic may be opaque or translucent, but preferably is transparent. The backing preferably is made of a paper product, such as cardboard, but plastic sheets and molded plastic backings may be used if desired. The cover may be attached to the backing by any number of conventional means, such as adhesives and staples, and may be formed with guides to accommodate the backing. If the backing is formed from molded plastic, the cover and backing may be provided with mating ridges and channels or other projections and depressions so that the cover and backing fit or snap together, and they may be heat sealed together.

Those aspects, however, and other finer details on the design, assembly, and fabrication of the packaging per se will not be discussed herein in further detail. Such matters are well within the skill of those in the art, and a variety of packaging suitable for cigarette lighters are known and may be used in the context of the subject invention.

In accordance with the subject invention, packaged lighter 40 further comprises a removable coupon sheet 47. It provides a substrate on which is imprinted a manufacturer coupon having machine readable code to facilitate automated processing of the manufacturer coupon. Coupon sheet 47 is separable from backing 42 so that a consumer may remove and redeem the manufacturer coupon.

It will be noted that coupon sheet 47 is provided on backing 42 via an onsert 48. Onsert 48 has an imprintable base substrate 48a that is affixed to the backing 42, typically by adhesives. Coupon sheet 47 in turn is affixed, typically with low tack adhesives, to base substrate 48. Base substrate 48a is typically not removable in the ordinary course of use, but coupon sheet 47 may be peeled easily from base substrate 48a. Alternately, a flat or folded coupon sheet may be carried in a pocket formed by adhering a top, enveloping substrate layer to an onsert base substrate. The coupon sheet then would be removed by peeling or tearing away the top substrate layer of the onsert. In either event, the onset substrate layers, such as base substrate 48a, would commonly be imprinted with various branding or other advertising messages, while the coupon sheet, such as coupon sheet 47, would provide a substrate for imprinting a manufacturer coupon. Onsert 48 or other onserts could be affixed to packaged lighter 40 in any convenient location, either on backing 42 or on cover 43.

A coupon sheet also could be releasably affixed to packaged lighter 40 by adhesives is a fashion similar to the manner in which coupon sheet 17 is affixed to lighter 10. The adhesive may be substantially continuous, or it may be applied discontinuously, e.g., in spots or lines. Also, coupon sheets may be affixed at only one end thereof so as to make it readily apparent to the consumer that the manufacturer coupon may be removed from the packaged lighter or simply to make the manufacturer coupon more conspicuous. Furthermore, even where the substantial portion of a coupon sheet is adhered to the packaged lighter, areas near the edges of the coupon sheet may be left free of adhesive to facilitate removal of the coupon sheet by a consumer.

Likewise, such coupon sheets could be divided into two or more coupon sheets defined, preferably, by lines of perforations that facilitate separation of the various sections of the coupon, or a folded coupon sheet may be provided. Such folded sheets also could be provided with lines of perforations so that two or more coupon sheets are provided. If desired, folded coupon sheets could be tacked down, for example by a releasable adhesive, thereby requiring more consumer interaction with the coupon sheet.

Coupon sheets also could be provided on packaged lighters by laminate sheets similar to laminate sheet 27 on lighter 20 shown in FIGS. 3-4. A laminate sheet could be more or less continuously laminated, or only one end thereof laminated to provide a “booklet” of coupon sheets. In either event, the coupon sheets may be pealed successively away from the packaged lighter.

Coupon sheets also may be provided on the cover of the packaging or on any other suitable location. They also may be captured and carried within the packaging along with the lighter. The coupon sheets may be tacked down therein, or simply inserted during the packaging process. Moreover, while such blister packs and clamshells are the most common primary packaging for individual lighters, individual lighters may be packaged in boxes and as well as various wraps that either completely or partially envelope a lighter. Such boxes and wrapping may provide a substrate for additional advertising or may serve to protect the lighters. As used herein, however, “primary packaging” for lighters shall be understood to include any such wraps and other primary packaging materials in which a single or relatively small number of lighters are packaged for retail consumption.

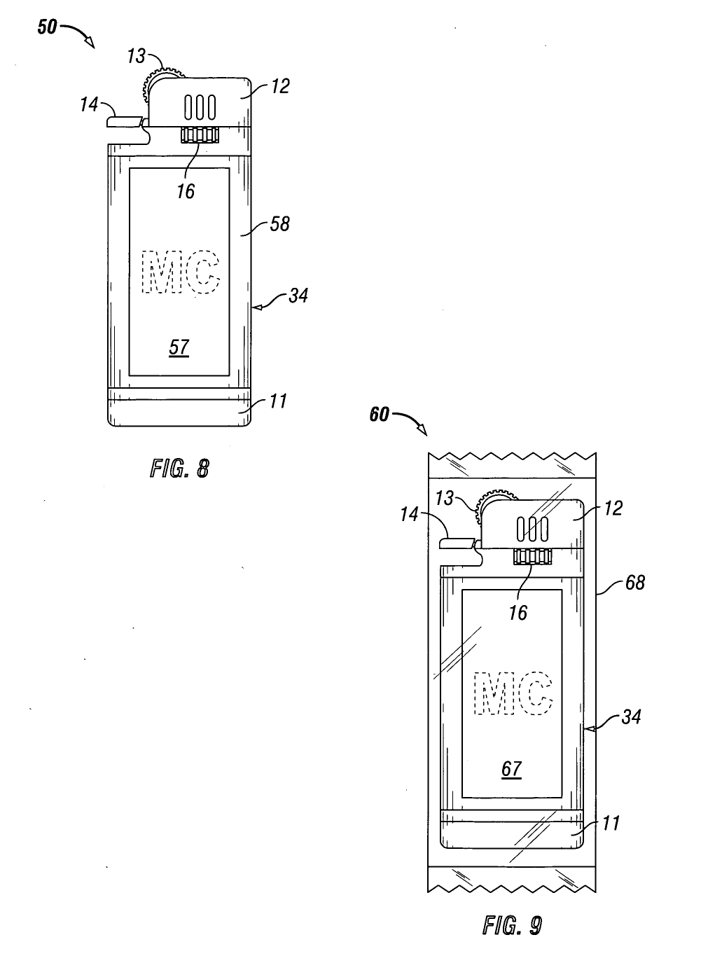

Thus, a third preferred embodiment comprises a packaged cigarette lighter having a manufacturer coupon, the lighter being packaged in primary packaging which captures a coupon sheet. More specific embodiments comprise a film wrap which captures a coupon sheet such as, for example, novel packaged lighter 50 shown in FIG. 8. Packaged lighter 50 comprises a cigarette lighter 34. Lighter 34 is identical to lighter 10 to shown in FIGS. 1-2, except that a coupon sheet 57 is laid over body 11 of lighter 34 and secured thereto by a shrink-wrap sleeve 58. Coupon sheet 57 provides a substrate on which is imprinted a manufacturer coupon having machine readable code to facilitate automated processing of the coupon. Sleeve 58 may be torn away by a consumer, thus providing access to coupon sheet 57 so that the consumer may remove and redeem the manufacturer coupon imprinted thereon. Coupon sheet 57 may be likely tacked down on body 11 by low tack adhesives, but preferably it is unadhered so that it will be readily available upon removal of sleeve 58. The exposed side of coupon sheet 57, if desired, may be imprinted with an advertising message alerting consumers to the presence of a manufacturer coupon on the other side of coupon sheet 57.

It also will be appreciated that more than one coupon sheet may be secured by a common shrink-wrap sleeve. The coupon sheets may be in the form of a booklet or otherwise adhered to each other, or they may be loose. Likewise, a large coupon sheet could be provided with folds so that it fits easily on or around the surface of the lighter. It also will be appreciated that, depending on the size of the coupon sheet or other preferences, a smaller sleeve may be provided, or a larger one, or the entire lighter may be shrink-wrapped so long as the coupon sheets are secured thereto. In any event, the coupon sheets may be removed easily by a consumer so that manufacturer coupons imprinted thereon may be redeemed. Moreover, instead of capturing a coupon sheet with a shrink-wrap sleeve, a manufacturer coupon may be imprinted thereon.

A variety of polymer plastic films may be used for shrink wrapping, but most commonly a polyolefin or polyvinylchloride film is used. A band or sleeve of the film may be placed over a lighter, or flat stock may be lightly heat tacked together to form a tube. Flat stock also may be folded, and then sealed on the overlap to form a bag around the entire lighter. The film then is exposed to heat, for example, by passing it through a heat tunnel in the packaging process, whereupon it shrinks over the lighter and secures coupon sheet thereto, all as well understood in the art.

Another example of this third preferred embodiment, novel packaged cigarette lighter 60 shown in FIG. 9, comprises a coupon sheet 67 which is laid over body 11 of lighter 34, and together with lighter 34 is wrapped in a plastic film, preferably a printed or clear plastic film such as cellophane packet 68. Coupon sheet 67, and the manufacturer coupon imprinted thereon, are readily visible to consumers and may be easily removed for redemption by tearing open packet 68. Coupon sheet 67 may be likely tacked down on body 11 by low tack adhesives, but preferably it is unadhered so that it will be readily available upon removal of sleeve 68. The exposed side of coupon sheet 67, if desired, may be imprinted with an advertising message alerting consumers to the presence of a manufacturer coupon on the other side of coupon sheet 67.

It also will be appreciated that more than one coupon sheet may be captured within a packet. The coupon sheets may be in the form of a booklet or otherwise adhered to each other, or they may be loose. Likewise, a large coupon sheet could be provided with folds so that it fits easily on or around the surface of the lighter. It also will be appreciated that, depending on the size of the coupon sheet or other preferences, a larger packet may be provided. A lighter and coupon sheet also may be wrapped in a variety of other ways such as, for example, “gift wrapping” a film around them. Pull ribbons and the like may be provided to facilitate removal of the film wrapping. In any event, the coupon sheets may be removed easily by a consumer so that manufacturer coupons imprinted thereon may be redeemed. Moreover, instead of capturing a coupon sheet with a shrink-wrap sleeve, a manufacturer coupon may be imprinted thereon. It will be appreciated that such packets and wrappings may be provided with a variety of film packaging commonly used for packing consumer products. Such films include paper-film, wax paper, and other synthetic or natural nonwoven fibrous substrates, and monolayer, multilayer, and coextruded sheets, such as those composed of high and low density polyethylene, polypropylene, ethylene vinyl alcohol, polyester, nylon, and other polymers and aluminum and other metallic alloys as are known in the art. The films typically are sealed by heat sealing. Packets similar to that shown in FIG. 9, however, may be formed by twisting the ends of the wrap, with or without ties holding the twist.

Thus, it will be appreciated that the invention provides for novel packaged cigarette lighters having removable coupon sheets that may be easily and neatly removed and that present the coupon sheet in a manner appealing to consumers. Since they may be easily separated and removed from the lighters, removable coupon sheets are expected to increase redemption rates for the coupons imprinted thereon. There is a positive correlation between the ease with which a consumer is able to collect a coupon and the rate at which the coupon is redeemed. The harder it is to collect a coupon, the lower will be the redemption rates. Moreover, since the packaging will be handled during a purchase and must necessarily be handled by a consumer in removing the cigarette lighter, the coupon inevitably will be noticed and detached from the packaging. The invention, however, is not limited to any particular method or means of releasably affixing a coupon sheet to a packaged cigarette lighter. Other such methods and means are known in the art, or may hereafter be developed, and they may be employed in the broader aspects of the invention.

Another common type of retail packaging is so-called retail ready packaging or displays, and they are almost universally the packaging by which cigarette lighters are presented in bulk for retail distribution. Retail ready displays for cigarette lighters typically are caddies which can accommodate a fairly large number of individual lighters. They usually have display areas upon which branding and advertising messages may be imprinted. They can be deployed with little or no setup, often on the sales counter or otherwise near the point of sale.

Thus, a fourth embodiment of the subject invention comprises a plurality of cigarette lighters packaged in a retail ready display. More specific embodiments include retail ready displays which comprise a tray accommodating a plurality of cigarette lighters. The display has a backing that extends from an end of the tray, usually the back end. A coupon sheet, or rather as would be more typical, a plurality of coupons sheets are releasably affixed to the display backing. The coupon sheets provide a substrate on which the manufacturer coupons are imprinted, and they are removable. The manufacturer coupons are redeemable by a consumer and include machine readable code associated therewith to facilitate automated processing of said coupons.

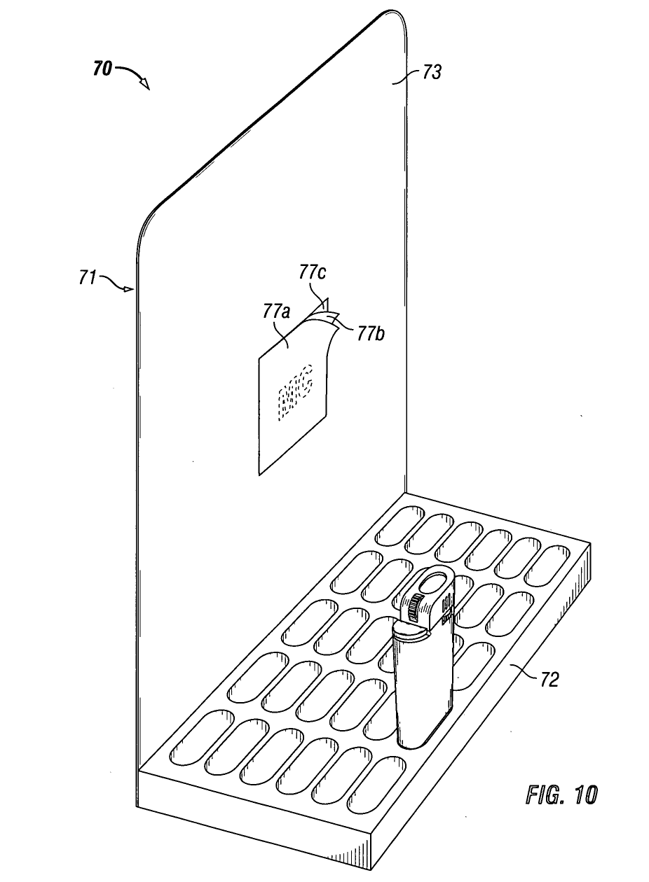

For example, the package of lighters 70 shown in FIG. 10 comprises a caddy 71. Caddy 71 is of typical design used for point-of-sale displays that may be set up, for example, on a sales counter. It has a molded plastic tray 72 into which preferably are formed individual recesses adapted to receive a plurality of lighters 34 (only one lighter 34 being shown for the sake of clarity). A display backing 73 extends upwardly from the back of tray 72. Typically, it will have various branding and other advertising messages imprinted thereon, and therefore, it usually is arranged so that lighters in caddy tray 72 may be viewed under or in front of backing 73. Those aspects, and other finer details on the design, assembly, and fabrication of the caddy per se will not be discussed herein in further detail. Such matters are well within the skill of those in the art, and a variety of bulk packaging suitable for cigarette lighters are known and may be used in the context of the subject invention.

In accordance with this aspect of the invention, packaged lighters 70 comprise a “booklet” of coupon sheets 77. A first coupon sheet 77a is adhered at its upper end to a second coupon sheet 77b. The remainder of coupon sheet 77a is unadhered to coupon sheet 77b so that it may be lifted away therefrom. Coupon sheet 77b is adhered to coupon sheet 77c in a similar manner, and successive coupons sheets in a similar manner, with the bottom coupon sheet being adhered to display backing 73. Coupon sheets 77 provide substrates on which are imprinted manufacturer coupons having machine readable code to facilitate automated processing of the manufacturer coupon. Each coupon sheet 77 may be peeled away from caddy 71 one at a time so that successive consumers may remove and redeem the manufacturer coupons imprinted thereon.

Typically, caddy 73 and other retail-ready packaging will be provided with a relatively large number of coupon sheets 77, since they typically display a relatively large number of lighters. A manufacturer usually will want to provide at least one coupon for each item in the packaging and perhaps more, since the caddy 73 will be viewed by many consumers who may not purchase a lighter. A lesser number of coupon sheets, however, may be provided if desired.

Thus, it will be appreciated that the invention provides for novel bulk retail packaging for cigarette lighters having removable coupon sheets that may be easily and neatly removed and that present the coupon sheet in a manner appealing to consumers. Since they may be easily separated and removed from the lighters, removable coupon sheets are expected to increase redemption rates for the coupons imprinted thereon. There is a positive correlation between the ease with which a consumer is able to collect a coupon and the rate at which the coupon is redeemed. The harder it is to collect a coupon, the lower will be the redemption rates. Moreover, since the caddy typically is placed at the point of sale, it will be viewed many times by consumers at the moment of executing a buying decision. Studies have shown that the rate of coupon redemption greatly increases if the coupons are presented in close proximity to the point of sale. The invention, however, is not limited to any particular method or means of releasably affixing a coupon sheet to bulk packaging for cigarette lighters. Other such methods and means are known in the art, or may hereafter be developed, and they may be employed in the broader aspects of the invention.

In general, the coupon sheets used with the novel cigarette lighters and packaging may be composed of any of a wide variety of imprintable substrates conventionally used in printed advertising materials. Such substrates include paper, such as bond and machine glazed, cellophane, and other synthetic or natural nonwoven fibrous substrates, monolayer, multilayer, and coextruded films, such as those composed of high and low density polyethylene, polypropylene, ethylene vinyl alcohol, polyester, nylon, and other polymers, and aluminum and other metallic alloys, and paper-film and other laminate substrates. Suitable films will enable the imprinting of a manufacturer coupon. They also should have tear, tensile, stiffness, memory, and other physical characteristics that render them suitable for use in automated printing and manufacturing equipment. Bond, book, and other types of paper based stock are preferred as they are relatively inexpensive, may be handled relatively easily by automated equipment, and provide an excellent substrate for conventional printing processes. Machine glazed paper is especially preferred as it will provide improved print quality. Where there are multiple coupon sheets the coupon sheets may be made of the same or different materials. In general, the choice of material for the coupon sheets will be determined by those and other factors well known to those skilled in the art of packaging, and many suitable materials are commercially available.

The manufacturer coupon may be imprinted by any of a number of conventional printing processes well known to workers in the art. It will be further appreciated that, in the context of the subject invention, imprinting will be understood not only to include such printing processes, but also impressing, watermarking, bonding, fusing, embossing, burning, stenciling and other processes by which indicia may be imparted to the substrate to communicate the desired manufacturer coupon. The precise method of imprinting will be coordinated with the choice of substrate, and vice versa. Printing the manufacturer coupons, however, is preferred for cost reasons and because it allows greater flexibility in presenting the manufacturer coupon. Preferably the manufacturer coupons are preprinted on a suitable web prior to packaging.

The manufacturer coupon, of course, will be determined by the advertiser. It will be appreciated, however, that since the coupon sheet includes a manufacturer coupon redeemable by a consumer, it will be advisable to select substrates and imprinting methods that provide relatively high quality printing. That will improve machine readability of the bar code that as a practical matter must be associated with a manufacturer coupon.

It also will be appreciated that the novel cigarette lighters and packaging, consistent with current practice, typically will also have an imprinted message on at least its exterior surface. Such messages most commonly will provide at least a branding message, but especially in regard to the novel packaged lighters, the messages may and typically will include identification and information on the product and the entity that is sponsoring or otherwise distributing the product. Thus, while it generally is preferred that the branding message be unobscured at all times, advertising messages may be laid out such that they are revealed upon removal of a coupon sheet. The coupon sheets, however, may be translucent or transparent to allow consumers to view indicia printed on the product such as a sponsorship message. Moreover, although the novel products are particularly useful in disseminating manufacturer coupons other than those pertaining to the sponsor of the product, all messages imprinted thereon may pertain to the manufacturer providing the coupon.

Moreover, it will be appreciated that various embodiments of the novel cigarette lighters and packaging provide coupon sheets upon which a manufacturer coupon may be imprinted, yet those products do not necessarily occupy significantly more space than similarly configured conventional products. Even when multiple coupon sheets or folded coupon sheets are incorporated into the cigarette lighter or packaging, the cigarette lighter or packaging is not necessarily significantly larger than conventional lighters and packaging and their overall size is virtually unchanged. This can be a significant advantage as a manufacturer may be able to package and ship the novel cigarette lighters and packaged cigarette lighters in the same packaging and containers as are used for its conventional product. The novel cigarette lighters and packaging may be sized according to such conventions, yet still provide a sufficiently large area for imprinting manufacturer coupons, an advantage that is greater as the size of the product or its packaging is diminished. It also will be appreciated that many embodiments of the novel cigarette lighters and packaging may be produced by making relatively minor modifications to conventional processes and machinery.

The methods of the subject invention are directed to disseminating manufacturer coupons to consumers. Such novel methods comprise providing cigarette lighters or their packaging with a manufacturer coupon which may be viewed by a consumer of the cigarette lighters, the cigarette lighters and packaging being one of the novel cigarette lighters and packaging disclosed herein. That is, the cigarette lighters and packaging are selected from the group consisting of the novel cigarette lighters and packaging described herein or any subgroup thereof. The cigarette lighters and packaging with the manufacturer coupon are distributed to a consumer outlet and then distributed to consumers associated with the consumer outlet. The manufacturer coupon is thereby distributed to consumers of the cigarette lighters.

While this invention has been disclosed and discussed primarily in terms of specific embodiments thereof, it is not intended to be limited thereto. Other modifications and embodiments will-be apparent to the worker in the art.

What is claimed is:

1. A method for providing a manufacturer coupon for dissemination to a target consumer group, which method comprises:
(a) packaging a cigarette lighter for retail distribution;
(b) wherein said cigarette lighter is packaged with a manufacturer coupon;
(c) wherein said manufacturer coupon is redeemable by a consumer and includes machine readable code associated therewith to facilitate automated processing of said coupon; and
(d) providing said lighters for distribution to a consumer outlet associated with said target consumer group whereby said manufacturer coupon may be provided to said target consumer group.

2. The method of claim 1, wherein said cigarette lighter is packaged with a removable coupon sheet, said coupon sheet providing a substrate on which said manufacturer coupon is imprinted.

3. The method of claim 2, wherein said method comprises releasably affixing said coupon sheet to said lighter, wherein said coupon sheet is separable from said lighter.

4. The method of claim 3, wherein said cigarette lighter comprises a body having a chamber formed therein for holding liquid fuel and said coupon sheet is releasably affixed to said body.

5. The method of claim 1, wherein said method comprises packaging said cigarette lighter in primary packaging wherein said manufacturer coupon is imprinted on said primary packaging.

6. The method of claim 2, wherein said method comprises packaging said cigarette lighter in retail packaging wherein said coupon sheet is releasably affixed to said retail packaging or captured therein.

7. The method of claim 6, wherein: said retail packaging comprises primary packaging having a backing and a cover, said cover defining a cavity receiving said lighter and said backing and said cover substantially enclosing said lighter; and said method comprises releasably affixing a coupon sheet to said backing or said cover.

8. The method of claim 6, wherein said coupon sheet is captured in said primary packaging.

9. The method of claim 1, wherein said method comprises packaging a plurality of said cigarette lighters in a retail point-of-sale display comprising:
(a) a tray receiving said plurality of cigarette lighters;
(b) a display backing extending from one end of said tray; and
(c) a plurality of coupon sheets releasably affixed to said display backing.

10. The method of claim 1, wherein said coupon includes a bar code associated therewith.

11. The method of claim 1, wherein said coupon includes a UPC bar code utilizing the UCC/EAN-128 Article Numbering System or the GS 1 DataBar coupon code.

12. The method of claim 1, wherein said manufacturer coupon is for a tobacco or alcohol to product.

13. A cigarette lighter having a manufacturer coupon, wherein said cigarette lighter comprises:
(a) a body having a chamber formed therein for holding liquid fuel;
(b) a coupon sheet releasably affixed to said body, said coupon sheet providing a substrate on which said manufacturer coupon is imprinted and being separable from said body; wherein said manufacturer coupon is redeemable by a consumer and includes machine readable code associated therewith to facilitate automated processing of said coupon.

14. The cigarette lighter of claim 1, wherein said cigarette lighter is packaged with a removable coupon sheet, said coupon sheet providing a substrate on which said manufacturer coupon is imprinted.

15. The cigarette lighter of claim 14, wherein said coupon sheet is releasably affixed to said lighter, wherein said coupon sheet is separable from said lighter.

16. The cigarette lighter of claim 15, wherein said cigarette lighter comprises a body having a chamber formed therein for holding liquid fuel and said coupon sheet is releasably affixed to said body.

17. The cigarette lighter of claim 13, wherein said coupon includes a bar code associated therewith.

18. The cigarette lighter of claim 13, wherein said coupon includes a UPC bar code utilizing the UCC/EAN-128 Article Numbering System or the GS1 DataBar coupon code.

19. The cigarette lighter of claim 13, wherein said manufacturer coupon is for a tobacco or alcohol product.

20. A cigarette lighter packaged in primary packaging having a manufacturer coupon, wherein said primary packaging comprises:
(a) a backing;
(b) a cover defining a cavity receiving said lighter, said cover being connected to said backing such that said backing and said cover substantially enclose said lighter;
(c) a coupon sheet releasably affixed to said backing or said cover, said coupon sheet providing a substrate on which said manufacturer coupon is imprinted and being separable from said backing; wherein said manufacturer coupon is redeemable by a consumer and includes machine readable code associated therewith to facilitate automated processing of said coupon.

21. The packaging of claim 20, wherein said coupon includes a bar code associated therewith.

22. The packaging of claim 20, wherein said coupon includes a UPC bar code utilizing the UCC/EAN-128 Article Numbering System or the GS1 DataBar coupon code.

23. The packaging of claim 20, wherein said manufacturer coupon is for a tobacco or alcohol product.

24. A plurality of cigarette lighters packaged in a retail point-of-sale display having a manufacturer coupon, said display comprising:
(a) a tray receiving said plurality of cigarette lighters;
(b) a display backing extending from one end of said tray; and
(c) a coupon sheet releasably affixed to said display backing, said coupon sheet providing a substrate on which said manufacturer coupon is imprinted and being separable from said backing; wherein said manufacturer coupon is redeemable by a consumer and includes machine readable code associated therewith to facilitate automated processing of said coupon.

25. The display of claim 20, wherein said coupon includes a bar code associated therewith.

26. The display of claim 20, wherein said coupon includes a UPC bar code utilizing the UCC/EAN-128 Article Numbering System or the GS1 DataBar coupon code.

27. The display of claim 20, wherein said manufacturer coupon is for a tobacco or alcohol product.
